(19) United States
(12) Patent Application Publication
(10) Pub. No.: US 2017/0142557 A1
(43) Pub. Date: May 18, 2017

(54) Group Communication in a Multicast-Broadcast Single Frequency Network

(71) Applicant: TELEFONAKTIEBOLAGET LM ERICSSON (PUBL), Stockholm (SE)

(72) Inventors: Magnus Tränk, Lerum (SE); Joakim Åkesson, Landvetter (SE)

(21) Appl. No.: 14/653,301

(22) PCT Filed: Jun. 17, 2015
(86) PCT No.: PCT/EP2015/063659

§ 371 Date: Jun. 18, 2015

(51) Int. Cl. H04W 4/06; H04W 72/00

(52) U.S. Cl. CPC H04W 4/06; H04W 72/005; H04W 84/042

(57) ABSTRACT

The present disclosure relates to a wireless communication system (200) comprising at least a first MBSFN (210), Multicast-Broadcast Single Frequency Network, and a second MBSFN (220). The MBSFNs comprise MBSFN transmitters (215, 225, 230) arranged to broadcast transport blocks using communications resources (f1, f2, f3, f4). The transport blocks transport services (A,B,C) to one or more wireless devices (130, 131, 132, 133) in the wireless communication system (200), wherein at least one of the MBSFN transmitters (230) is associated to both the first (210) and to the second (220) MBSFN, and is arranged to transmit transport blocks transporting one or more services in both the first and in the second MBSFN.

### TECHNICAL FIELD

The present disclosure relates to Multicast-Broadcast Multimedia Services (MBMS), and in particular to service continuity in a wireless communication system comprising at least a first Multicast-Broadcast Single Frequency Network (MBSFN) and a second MBSFN.

### BACKGROUND

In group communication the same information or service is delivered to multiple users. If many users are located within the same area, multicast or broadcast based transmission using, e.g., Multicast-Broadcast Multimedia Services (MBMS) is efficient. In MBMS, one or more services are broadcasted to intended users by using one or more shared communications resources. If users are spread over an area wider than a Multicast-Broadcast Single Frequency Network (MBSFN) area, the service or services have to be delivered over multiple MBSFNs. It is then highly desirable to provide service continuity between MBSFN areas, meaning that a group communication can continue without a need to reestablish ongoing group calls when a wireless device participating in the group communication moves from one MBSFN to another MBSFN.

MBSFN transmissions are unidirectional, meaning that there is no feedback channel from wireless devices participating in the group communication back to the MBSFN, which in turn means that the MBSFN radio transmission needs to be robust enough that retransmissions are not needed. Another consequence of the unidirectional transmission is that wireless devices may listen to MBSFN transmissions without connecting to a cellular network comprising the MBSFN, which is an advantage in some scenarios. A service continuity method disclosed in 3GPP TS 23.468 v.13.0.0 2015-03, relies on a methodology to transfer group communication from multicast to unicast; in unicast there is one information stream broadcast for each intended user. A user or wireless device which is taking part in a group communication and which moves from a first to a second MBSFN area will, according to the method disclosed in 3GPP TS 23.468 v.13.0.0 2015-03, need to first have its communication transferred by the network from multicast in the first MBSFN area to unicast, and then back to multicast in the second MBSFN area. This is an inefficient way to provide service continuity and which may fail, e.g., when the unicast network is congested. Furthermore, transferring a user or wireless device to unicast requires that the wireless device connects to and/or registers with the network, which may not be possible, or may at least be undesirable.

It is therefore desired to provide a wireless communication system that is able to handle a situation when a user moves from one MBSFN to another during an ongoing group call without having to transfer the communication from multicast to unicast.

### SUMMARY

It is an object of the present disclosure to provide at least a wireless communication system that is able to handle a situation when a user moves from one MBSFN area to another during an ongoing group call, i.e., service continuity, without having to rely on transferring the communication from multicast to unicast. A wireless device, a server device, and methods are also provided herein directed at the issues discussed above.

Said object is obtained by means of a wireless communication system comprising at least a first Multicast-Broadcast Single Frequency Network (MBSFN) and a second MBSFN. The first and second MBSFN comprise MBSFN transmitters arranged to broadcast transport blocks by using communications resources. The transport blocks transport services to one or more wireless devices in the wireless communication system. At least one of the MBSFN transmitters is associated to both the first and to the second MBSFN, and is arranged to broadcast transport blocks transporting one or more services in both the first and in the second MBSFN.

A number of advantages are obtained by means of the present disclosure. Mainly, a less complicated service continuity process is provided, having a higher probability of being successful even in a congested network. Also, a wireless device may by the proposed technique move between different MBSFNs without connecting to a cellular network comprising the MBSFNs.

According to aspects, said communications resources comprise any of frequency bands, time slots, LTE sub-frames, or a combination of frequency bands and time slots. Furthermore, the wireless communication system may be a cellular communication system, and an MBSFN transmitter may be a Radio Base Station (RBS), or an eNodeB, of the cellular communication system.

Hereby, since the disclosed techniques are applicable for a range of different communications resources and system architectures, the techniques can be applied in a variety of different communication systems. Thus, flexibility in deploying broadcasting functionality in a wireless communication network is achieved, while maintaining said less complicated service continuity process.

According to some aspects, a first sub-set of transport blocks broadcasted in the first MBSFN by the at least one MBSFN transmitter associated to both the first and to the second MBSFN, and a second sub-set of transport blocks broadcasted in the second MBSFN by said at least one MBSFN transmitter, are arranged to transport the same service but using different communications resources.

Hereby, a wireless device participating in group communication involving said same service can receive the service on two different communications resources at the same time, which enables seamless transition between MBSFNs, i.e., improved service continuity, which does not involve transferring a wireless device from multicast to unicast.

According to further aspects, said first and second sub-sets of transport blocks transporting the same service are combinable upon reception by a wireless device into combined transport blocks having an improved transport block quality compared to the transport block quality before combining.

Hereby, a wireless device may benefit from improved reception conditions due to the combining. On a network level, these improved reception conditions may allow for, e.g., a reduction in the number of reserved cells used in the wireless communication system. One or more service coverage areas related to MBMS may also be extended due to the combining.

There is also disclosed herein an MBSFN transmitter associated to both a first and to a second MBSFN, and arranged to broadcast transport blocks transporting one or more services in both the first and in the second MBSFN.

The above-mentioned object is further obtained by a wireless device arranged for MBSFN communication. The wireless device is arranged to receive first and second transport blocks which both transport a first service but using different communications resources. The wireless device is arranged to combine at least the received first and second transport blocks into a combined transport block having an improved transport block quality compared to a transport block quality before combining.

Hereby, a wireless device participating in group communication involving said same service can receive the service on two different communications resources at the same time, which, as already mentioned above, enables seamless transition between MBSFNs, i.e., improved service continuity. Also, since the wireless device can receive the service on two different communications resources at the same time, it may combine transport blocks. Thus an improved service reception condition due to the combining is achieved.

The above-mentioned object is further obtained by a wireless communication system server device arranged to at least partly control at least a first MBSFN and a second MBSFN. Each MBSFN comprises MBSFN transmitters arranged to broadcast transport blocks transporting services to one or more wireless devices. At least one of the MBSFN transmitters is associated to both the first and to the second MBSFN, and the server device is arranged to provide information to wireless devices regarding said broadcasted services.

Hereby, at least the above-mentioned advantages relating to a less complicated service continuity process are facilitated.

There is also disclosed herein a method performed in a wireless communication system with at least a first MBSFN and a second MBSFN. The MBSFNs comprise MBSFN transmitters. The method comprises associating an MBSFN transmitter to both the first and to the second MBSFN. The method also comprises broadcasting, by the MBSFN transmitter associated to both the first and to the second MBSFN, transport blocks in the first MBSFN and in the second MBSFN.

There is furthermore disclosed herein a method performed in a wireless device used for MBSFN communication. The method comprises receiving first and second transport blocks which both transport a first service but using different communications resources, and combining the received first and second transport blocks into a combined transport block having an improved transport block quality compared to a transport block quality before combining.

Apart from the above method, there is also provided herein computer programs comprising computer program code which, when executed in a communication system, a server device, or wireless device, causes the respective apparatus to execute methods according to the present teaching.

The methods and computer programs display advantages corresponding to the advantages already described in relation to corresponding above-mentioned devices.

### BRIEF DESCRIPTION OF THE DRAWINGS

The present disclosure will now be described in more detail with reference to the appended drawings, where

FIG. 1 shows a schematic view of a wireless communication network having two MBSFNs according to prior art;

FIG. 2 shows a schematic view of a wireless communication network having two MBSFNs according to aspects of the present disclosure;

FIG. 3a illustrates received signal quality in a border region between two MBSFNs according to prior art;

FIG. 3b illustrates received signal quality in a border region between two MBSFNs according to aspects of the present disclosure;

FIG. 4 schematically illustrates an example communications resource distribution between services in a first and in a second MBSFN according to aspects of the present disclosure;

FIG. 5 shows a schematic view of a wireless communication network having three overlapping MBSFNs according to aspects of the present disclosure;

FIG. 6 shows a flowchart illustrating methods performed in a wireless communication system according to aspects of the present disclosure;

FIG. 7 shows a flowchart illustrating methods performed in a wireless device according to aspects of the present disclosure;

FIG. 8 schematically illustrates a wireless communication system according to aspects of the present disclosure;

FIG. 9 schematically illustrates a wireless device according to aspects of the present disclosure;

### DETAILED DESCRIPTION

Aspects of the present disclosure will now be described more fully with reference to the accompanying drawings. The various devices, systems, computer programs and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

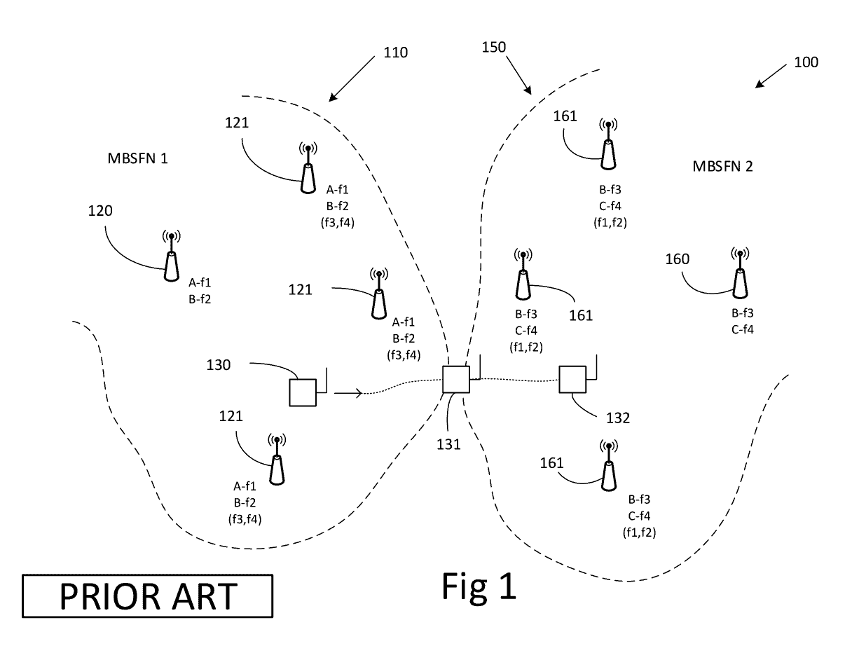

FIG. 1 shows a schematic view of a wireless communication network 100 having two Multicast-Broadcast Single Frequency Networks (MBSFNs) according to prior art. A first MBSFN 110 comprises MBSFN transmitters 120, 121 which are arranged to broadcast two services; service A and service B. Service A is broadcasted using communications resource f1, and service B is broadcasted using communications resource f2.

The communications resources f1, f2, used for broadcasting varies from network to network. One example of such a communications resource is a frequency band. Another example of a communications resource is a time slot. Of course, combinations of time slots and frequency bands may also be used to define specific communications resources. Thus, yet another example of a communications resource is a sub-frame in a Long Term Evolution (LTE) cellular communications system. Other communications resources which are conceivable for use in broadcast comprise different orthogonal codes or different orthogonal polarizations.

Broadcasted services and corresponding communications resources are illustrated in FIG. 1 next to each MBSFN transmitter and formatted as ‘service-communications resource’, e.g., ‘A-f1’ for service ‘A’ broadcasted using communications resource ‘f1’ and ‘B-f2’ for service ‘B’ broadcasted using communications resource ‘f2’.

Herein, according to some aspects, MBSFNs are assumed to broadcast transport blocks according to TS 36.213 E-UTRA; physical layer procedures V12.5.0 2015-03. It is referred to this document, and references cited therein, for exemplary details regarding transport block format.

In one exemplary LTE setting, a wireless device wanting to participate in group communication first receives System Information Block (SIB) 2 from an MBSFN transmitter which contains information relating to the sub-frames that are being used for Multicast-Broadcast Multimedia Services (MBMS). The wireless device also receives SIB 13 which enables the wireless device to locate the so-called MBMS Control Channel (MCCH) in the LTE radio frame structure. The MCCH, in turn, carries information allowing the wireless device to discover which Temporary Mobile Group Identities (TMGI) that are available, and where broadcasted media corresponding to the TMGIs can be found, i.e., which communications resources that are used for broadcasting which services.

Herein, the actual broadcasted media, the TMGI, the MCCH, and the SIB 2 and SIB 13 are all broadcasted using communications resources.

In addition to the mechanisms discussed above, a wireless device may also receive one or more service announcements. A service announcement is a message, often delivered wirelessly over the same interface as the MBMS broadcast, which contains information about a broadcasted service. For instance, a service announcement may comprise information relating to an onset time of a particular broadcast, say a football game, and which TMGI that is associated with the broadcast. Once the service announcement has been received by a wireless device, the wireless device knows when to start participating in the group communication, and which communications resources to use for the participating.

Further details of the SIB 2 and SIB 13 are given in, e.g., 3GPP TS 36.331 V.12.5.0 2015-03 and references cited therein. Further details on the MCCH are given in, e.g., 3GPP TS 25.346 V.12.0.0 2014-03 and references cited therein.

FIG. 1 also shows a wireless device 130, 131, 132, which moves from the first MBSFN 110 into the second MBSFN 150. When the wireless device 130 is located within the coverage area of MBSFN 1, it will receive broadcasted services A and B on communications resources f1 and f2, respectively. However, as the wireless device 131 is leaving the first MBSFN 110, the radio transmissions on the first and second communications resources will become weaker, and eventually services in MBSFN 1 can no longer be successfully delivered to the wireless device 131. According to the service continuity method disclosed in 3GPP TS 23.468 v.13.0.0 2015-03, the wireless device will have its group communication, i.e., its services A and/or B, transferred to unicast. It is noted that the transfer to unicast involves the wireless device connecting to the cellular network comprising the MBSFN, e.g., an LTE network or other cellular network, including future 5G cellular networks, in case the wireless device had not done so earlier.

In an LTE setting, a wireless device not having to connect to the cellular network, means that it can stay in Radio Resource Control (RRC) Idle mode where it is silent and its cell location is unknown. A wireless device connecting to the cellular network means that the wireless device has to enter RRC connected mode.

The wireless device 132 will eventually come in reach, and/or be handed over, to an MBSFN transmitter, e.g., a radio base station (RBS) or eNodeB, in the second MBSFN 150. The wireless device 132 will then receive SIBs and MCCH to learn about services offered in that second MBSFN, whereupon it can be transferred back from unicast to multicast in the second MBSFN. In the scenario illustrated in FIG. 1, the wireless device 132 may resume participating in group communication of service B. According to the example of FIG. 1, service A is not available in MBSFN 2.

Thus, there are drawbacks associated with moving from the first to the second MBSFN illustrated in FIG. 1. First, the transfer to unicast represents a risk, since this transfer to unicast may not always be flawless and may lead to outage in the group communication. For instance, there may not be room for the transfer to unicast in case of congestion in the unicast network. Also, this transfer to unicast involves a significant amount of network signaling, which takes time. There is therefore in some cases a considerable delay associated with the transfer from multicast to unicast and back.

Another drawback in the prior art is also illustrated in FIG. 1. In current solutions the MBSFN areas are normally surrounded by several MBSFN transmitters, or cells, that are configured to not use the same radio resources as the cells are using within the MBSFN. These cells are called reserved cells in MBMS-related literature, and are used to mitigate radio interference problems. The use of reserved cells is advantageous for both the MBSFN and for the border cells outside the MBSFN. However, the use of reserved cells significantly impacts the resource efficiency in the wireless communication system 100 since these cells do not transmit on a subset of available communications resources.

Reserved cells are illustrated in FIG. 1 by communications resources within parentheses. I.e., an MBSFN transmitter 121 in the first MBSFN which is not using communications resources f3 and f4 in order to protect broadcasts in the second MBSFN 150 is shown with the text ‘(f3, f4)’ in FIG. 1. Likewise, an MBSFN transmitter 161 in the second MBSFN 150 which is not using communications resources f1 and f2 in order to protect broadcasts in the first MBSFN 110 is shown with the text ‘(f1, f2)’ in FIG. 1.

The two MBSFNs illustrated in FIG. 1 are associated with MBSFN areas or MBSFN coverage areas marked in FIG. 1 by dashed lines. Herein, a coverage area is to be construed as a geographical area, volume, or region wherein a given transmitted radio signal can be received and the information carried by the radio signal successfully interpreted, possibly using also other sources, such as other radio signals transmitted in other coverage areas or networks. Thus, to exemplify, in case the radio signal carries data packets, a coverage area may be defined as an area where a probability of data packet loss after processing of any received radio signals is below some acceptable packet loss probability or bit error rate. In case the radio signal or signals carries voice, a coverage area may, e.g., be defined as an area wherein received signal quality after processing of any received radio signals is sufficient in order for voice quality to be at an acceptable level.

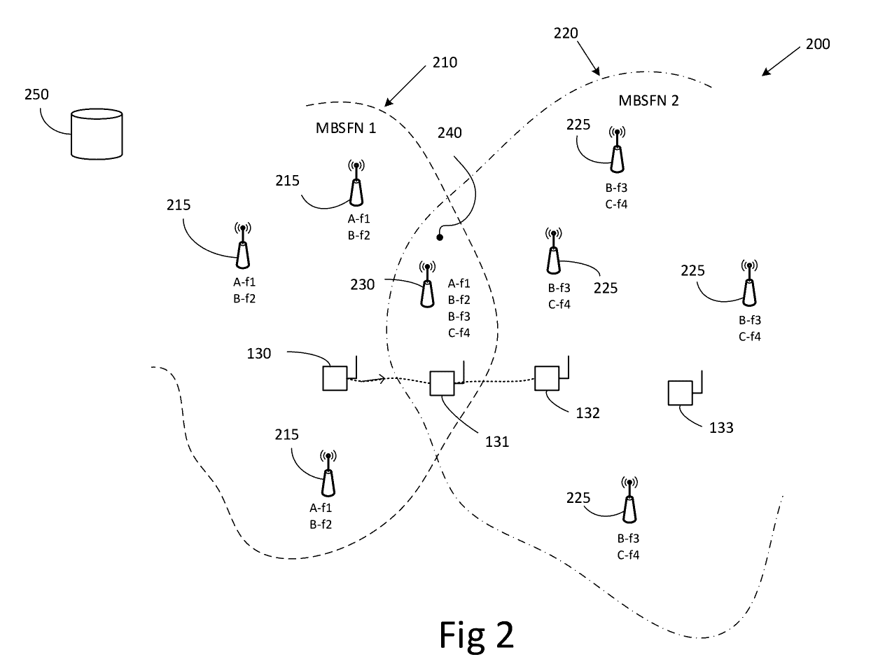

FIG. 2 shows a schematic view of a wireless communication network 200 having two MBSFNs, a first 210 and a second 220, just like in FIG. 1. By comparing networks in FIG. 2 and FIG. 1, it is noted that in FIG. 2, one of the MBSFN transmitters 230 is associated with both the first 210 and with the second MBSFN 210. As will be shown below, this difference provides several advantages, for instance an improved service continuity between the first 210 and the second 220 MBSFN.

The MBSFN transmitter 230 is associated to both the first 210 and to the second 220 MBSFN, and arranged to broadcast transport blocks transporting one or more services in both the first and in the second MBSFN.

According to aspects, the MBSFN transmitter 230 is an RBS or an eNodeB in the wireless communication system 200.

It is appreciated that the present technique is applicable in indoor as well as in outdoor communication systems, and also in communication systems comprising both indoor and outdoor coverage areas. It is further appreciated that one MBSFN coverage area may be comprised in another MBSFN area, for instance when one MBSFN is deployed inside a building, which building is in turn located within a coverage area of a larger outdoor MBSFN. Also, more than one MBSFN transmitter may, according to aspects, be associated with both the first 210 and with the second MBSFN 210.

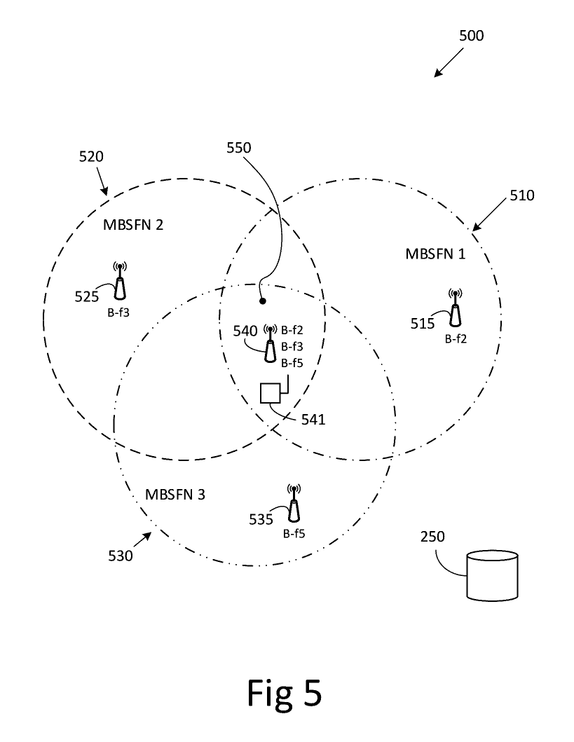

The notation used and explained in connection to FIG. 1 has been re-used in FIG. 2, and in particular the notation relating to services and communications resources. The same is true for FIG. 5 discussed below.

FIG. 2 illustrates a wireless communication system 200 comprising at least a first MBSFN 210 and a second MBSFN 220. The MBSFNs 210, 220 comprise MBSFN transmitters 215, 225, 230 arranged to broadcast transport blocks using communications resources f1, f2, f3, f4. The transport blocks are transporting services A, B, C to one or more wireless devices 130, 131, 132, 133 in the wireless communication system 200. As noted above, one difference that separates the wireless communication system in FIG. 2 from that illustrated in FIG. 1 is that at least one of the MBSFN transmitters 230 is associated to both the first 210 and to the second 220 MBSFN. This at least one MBSFN transmitter 230 is arranged to transmit transport blocks transporting one or more services in both the first and in the second MBSFN. According to the example shown in FIG. 2, a service A is broadcast in MBSFN 1 using communications resource f1, a service C is broadcast in MBSFN 2 using communications resource f4, and a service B is broadcast in both MBSFNI and in MBSFN 2, albeit using different communications resources f2 and f3.

Thus, a wireless device 130 located in the first MBSFN 210 and moving towards the second MBSFN will enter a coverage area 240 of the MBSFN transmitter 230 associated to both the first 210 and to the second 220 MBSFN. The wireless device will therefore hear broadcasts of both MBSFNs at the same time. It can therefore traverse MBSFN borders without need for unicast transmission, since it can switch the receiving of service B from communications resource f2 to communications resource f3 while in the coverage area 240 of the at least one MBSFN transmitter 230 associated to both the first 210 and to the second 220 MBSFN.

In other words, wireless devices listening to group communications broadcasted in two neighboring MBSFNs may move between these MBSFN areas without service disruptions or need for transfer to unicast. If the same service is broadcasted to overlapping areas, i.e., some border cells or MBSFN transmitters participate in the transmission in both MBSFN areas, service continuity may be achieved if the wireless device is able to receive from the two MBSFNs concurrently.

As noted above in connection to FIG. 1, the communications resources may comprise any of frequency bands, time slots, a combination of frequency bands and time slots, or sub-frames of an LTE cellular communication system.

In one exemplary LTE setting, a wireless device wanting to move between MBSFN 1 and MBSFN 2 and entering the coverage area 240 of the at least one MBSFN transmitter 230 associated to both the first 210 and to the second 220 MBSFN will receive SIB 2 from the MBSFN transmitter 230 which contains information relating to the sub-frames that are being used for MBMS in both MBSFN 1 and MBSFN 2. The wireless device also receives SIB 13 which enables the wireless device to locate MCCH in the LTE radio frame structure in both MBSFN 1 and MBSFN 2. The MCCH, in turn, carries information allowing the wireless device to discover which TMGI that are available, and where broadcasted media corresponding to the TMGIs can be found, i.e., which communications resources that are used for broadcasting which services in both MBSFN 1 and MBSFN 2. The wireless device can therefore listen in to service B in MBSFN 2 before the service B weakens in MBSFN 1. Thus, service continuity is improved without transferring the wireless device to unicast.

Another way to describe the wireless communication system 200 illustrated in FIG. 2 is that it comprises at least a first and a second MBSFN which together cover at least one overlapping region, exemplified in FIG. 2 by the overlapping region 240 between the first 210 and the second 220 MBSFN. The first and second MBSFN are arranged to broadcast transport blocks transporting services to wireless devices 130, 131, 132, 133, wherein at least a sub-set of transport blocks broadcasted in the first and in the second MBSFN are transporting the same service.

Thus, the proposed solution provides a simpler service continuity process with a higher probability to be successful even in presence of network congestion. Furthermore, the solution can be significantly more resource efficient since it may result in using less reserved cells, as will be further discussed below.

According to aspects of the present disclosure, the wireless device may be a mobile phone, a smart phone, a user equipment (UE), a laptop, or any other mobile or fixed wireless device with functionality to partake in group communication.

According to some aspects, listening to or participating in a group communication comprises receiving System Information Block (SIB) 2, SIB 13 and Multi-Cast Control Channel (MCCH) ahead of having to receive the associated Multi-Cast Traffic Channel (MTCH). Furthermore, if transport blocks from the two MBSFNs are carrying the same service and are combinable upon reception by the wireless device, then the signal quality requirement on received transport blocks may be relaxed in some border areas. Meaning that less border cells need to be allocated for interference mitigation reasons, i.e., reserved cells, and therefore the overhead is significantly reduced and the resource efficiency is significantly improved.

According to aspects, the wireless communication system 200 is a cellular communication system. In this case an MBSFN transmitter 215, 225, 230 is a Radio Base Station (RBS) or an eNodeB, of the cellular communication system.

With reference to the example wireless communication system illustrated in FIG. 2, there is at least one MBSFN transmitter 230 broadcasting a service, in this case service B, using two different communications resources, in this example f2 and f3. In other words, according to aspects of the present technique, a first sub-set of transport blocks broadcasted in a first MBSFN 210 by at least one MBSFN transmitter 230 associated to both the first 210 and to the second 220 MBSFN, and a second sub-set of transport blocks broadcasted in the second MBSFN 220 by said at least one MBSFN transmitter 230, are arranged to transport the same service B but using different communications resources B-f2, B-f3.

According to aspects, the first and second sub-sets of transport blocks transporting the same service are combinable upon reception by a wireless device 131 into combined transport blocks having an improved transport block quality compared to the transport block quality before combining. This means that if the same service is transmitted in two MBSFNs, e.g., service B in FIG. 2 transmitted from the MBSFN transmitter 230 associated to both MBSFNs, then a wireless device 131 that is positioned to receive signals from both MBSFNs at the same time will receive both service B broadcasts transmitted in different communications resources, e.g., in different sub-frames of an LTE cellular communication system.

Now, if there are more bit errors than it is possible to error correct using one transport block, the wireless device 131 may perform error correction by also considering the second or additional transport block or blocks received on the other communications resource, and thus increase the probability of error correcting the block. The sub-set of transport blocks transporting the same service are thus combinable upon reception into combined transport blocks having an improved transport block quality compared to the transport block quality before combining.

As an alternative or complement to performing error correction based on more than one received transport block, the wireless device 131 may combine the two transport blocks prior to performing error correction, i.e., perform soft receive diversity combining of the transport blocks transporting the same service.

As a further alternative or complement to performing error correction based on more than one received transport block, the wireless device 131 may perform error correction on both transport blocks individually, and then select the transport block most likely to be correctly decoded as the transport block to use, and discard the other transport block. The transport block most likely to be correctly decoded can be selected by, e.g., determining a Hamming distance between a received transport block and the transport block after error correction.

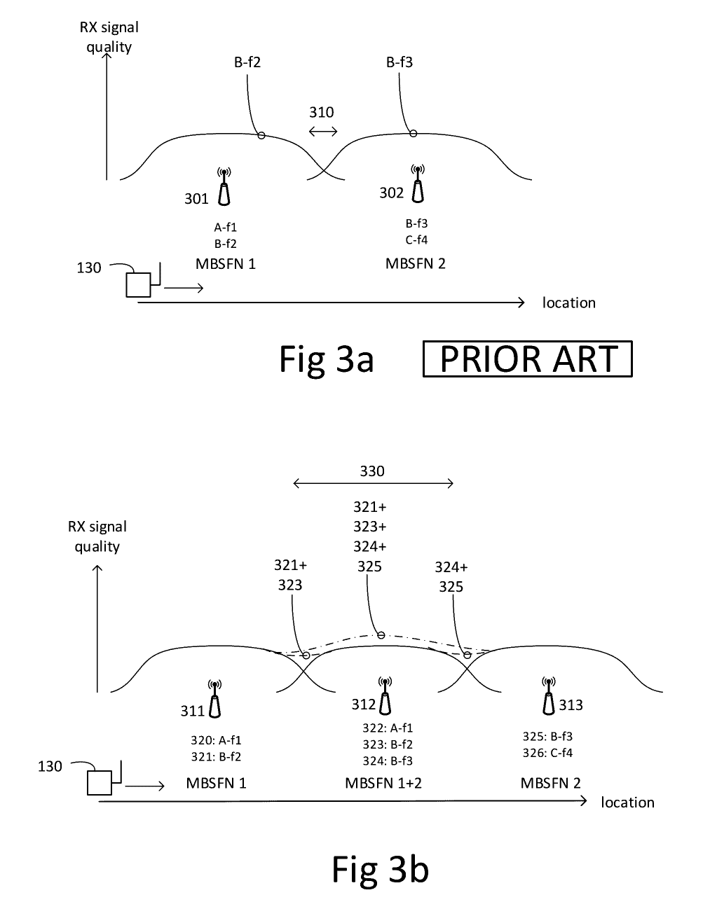

FIGS. 3a and 3b further illustrate a technical effect of the present teaching as compared to prior art, e.g., that disclosed in 3GPP TS 23.468 v.13.0.0 2015-03. FIGS. 3a and 3b schematically illustrate received signal quality on y-axis vs location of a group communication receiver, such as one of the wireless devices shown in FIGS. 1 and 2, in relation to the location of MBSFN transmitters on x-axis.

In FIG. 3a neither of the two MBSFN transmitters 301, 302 is associated to more than one MBSFN. Thus, a wireless device located in a border region 310 between MBSFNs may, according to 3GPP TS 23.468 v.13.0.0 2015-03, have to be transferred to unicast in order to provide service continuity for service B which is broadcasted using communications resource f2 by one MBSFN transmitter 301 and broadcasted using communications resource f3 by the other MBSFN transmitter 302.

In FIG. 3b an MBSFN transmitter 312 located in a border region 330 between two MBSFNs is associated to more than one MBSFN. Thus, this MBSFN transmitter 312 broadcasts a service B using two different communications resources f2 and f3. Consequently, a wireless device 130 moving from left to right in FIG. 3b, and wanting to receive service B, first receives this service from the left-most MBSFN transmitter using communications resource f2. Then, as the wireless device approaches the middle MBSFN transmitter 312, the wireless device benefits from both broadcasts using communications resource f2. This is illustrated in FIG. 3b by the dashed line 321+323. The wireless device then gradually starts to receive the broadcast from the middle MBSFN transmitter 312 with high signal quality, while the broadcast from the left-most MBSFN transmitter wanes. However, when in reach of the middle MBSFN transmitter 312, the wireless device also learns that the same service B is also broadcasted using a second communications resource f3, 324. Hence, the wireless device may start listening to this new broadcast in good time before the broadcast using communications resource f2 wanes. Consequently, service continuity is provided for service B as the wireless device moves from MBSFN 1 into MBSFN 2.

It is appreciated that the MBSFN transmitter 312 which is associated to more than one MBSFN need not, according to some aspects, broadcast all services of both MBSFNs. This is illustrated in FIG. 3b by the middle MBSFN transmitter 312 only broadcasting services A and B, and not C which is broadcasted by the right-most MBSFN transmitter 313. Thus, the example shown in FIG. 3b differs from the example shown in FIG. 2 in that the MBSFN transmitter associated to more than one MBSFN transmits services A, B and C in FIG. 2, and only services A and B in FIG. 3b. Both scenarios may occur according to aspects of the present technique.

According to some aspects, as discussed above, the wireless device may combine same service broadcasts on more than one communications resource. This results in further improvements in received signal quality, and is illustrated by the dash-dotted line 321+323+324+325. This further increase in received signal quality will, according to some aspects, allow for a reduced number of reserved cells in the wireless communication system.

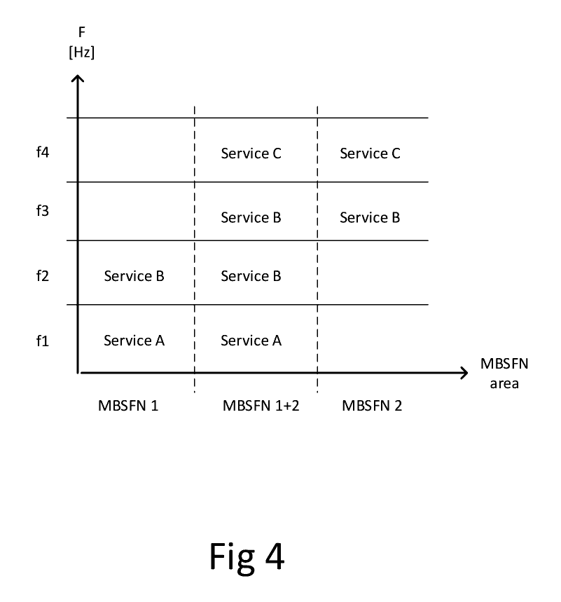

FIG. 4 schematically illustrates an example communications resource distribution between services A, B, C, and D in a first and in a second MBSFN according to aspects of the present disclosure. The distribution illustrated in FIG. 4 is the same distribution as is used in the example wireless communication system 200 illustrated in FIG. 2. It is noted that an MBSFN area exists, MBSFN 1+2, where broadcasts from both MBSFNI and MBSFN 2 can be received by a wireless device. It is furthermore appreciated that the communications resources are not necessarily frequency bands as shown in FIG. 4, but may also be, e.g., time slots or LTE sub-frames, as discussed above.

Turning back again to FIG. 2, it is noted that the wireless communication system 200, according to some aspects, further comprises at least one server device 250 arranged to provide information to the one or more wireless devices 130, 131, 132, 133 regarding broadcasted services in the first and in the second MBSFN. Thus, a wireless device listening to messages originating at the server device learns about MBMS broadcasts in the wireless communication system.

According to some aspects, the server device 250 comprises a Group Communication Service Application Server (GCS AS), according to 3GPP TS 22.468 V13.0.0 2014-12.

According to some aspects, the provided information comprises information regarding which transported services in the first MBSFN 210 and the second MBSFN 220 that are combinable upon reception by a wireless device 131. I.e., which transport blocks that transport the same service. This way, a wireless device receives information enabling it to apply combination of transport blocks in order to achieve the improved received signal quality discussed in relation to curve 321+323+324+325 of FIG. 3b.

Turning now to FIG. 5, which schematically illustrates a wireless communication system 500 with three overlapping MBSFNs. The wireless communication system 500 comprises first 510, second 520, and third 530 MBSFNs, wherein at least one of the MBSFN transmitters 540 is associated to both the first 510 and to the second 520 and to the third 530 MBSFN. Thus, a wireless device 541 in the vicinity 550 of said MBSFN transmitter 540 may receive, and possibly combine, broadcasts from three different MBSFNs, all relating to the same service A. Also, a wireless device may traverse borders between the different MBSFNs, i.e., may move between MBSFN transmitter 515, 525, 535 coverage areas while enjoying service continuity for service A, without having to be transferred to unicast as discussed above. Consequently, the present technique is not limited to two overlapping MBSFNs, but may be applied for any number of overlapping MBSFNs.

A wireless communication system 200, 500 implementing the proposed technique will not need as many reserved cells, at least partly due to improvements in received broadcast signal quality by the wireless devices, as a wireless communication system not implementing the proposed technique. Thus, the wireless communication systems 200, 500 illustrated in FIGS. 2 and 5 will, according to some aspects, have a reduced number of reserved cells compared to a wireless communication system according to prior art.

With reference to FIG. 2 and FIG. 5, there is also disclosed herein a wireless device 131, 541 arranged for MBSFN communication. The wireless device 131, 541 is arranged to receive first and second transport blocks which both transport a first service B but using different communications resources f2, f3, f5. The wireless device 131, 541 is arranged to combine at least the received first and second transport blocks into a combined transport block having an improved transport block quality compared to a transport block quality before combining.

The effect of the combining of transport blocks was discussed above in connection to FIG. 3. If there are more bit errors than possible to error correct using one transport block, the wireless device 131 may perform error correction by also considering the second or additional transport block or blocks, i.e., perform combining of transport blocks, and thus increase the probability of error correcting the block.

As an alternative or complement to performing error correction based on more than one received transport block, the wireless device 131 may combine the two or more received transport blocks prior to performing error correction, i.e., perform soft receive diversity combining.

As a further alternative or complement to performing error correction based on more than one received transport block, the wireless device 131 may perform error correction on both blocks individually, and then select the transport block most likely to be correctly decoded as the transport block to use, and discard the other transport block, i.e., perform combining of transport blocks based on selecting the best transport block. The transport block most likely to be correctly decoded being selected by, e.g., determining a Hamming distance between received transport block and the transport block after error correction.

According to aspects, the improved transport block quality is at least any one of improved signal to noise ratio, improved signal to interference and noise ratio, improved transport block error resilience, and improved transport block error probability.

According to aspects, the wireless device 131, 541 is further arranged to receive information regarding broadcasted services in one or more MBSFNs from a wireless communication system server device 250. The received information may comprise TMGI, Temporarily Mobile Group Identity, and/or information regarding which transported services in two or more MBSFNs that are combinable upon reception by a wireless device 131.

There is also disclosed herein a wireless communication system server device 250, shown in FIGS. 2 and 5, arranged to at least partly control the first MBSFN 210, 510 and the second MBSFN 220,520 and possibly also the third MBSFN 530. Each MBSFN comprises MBSFN transmitters 215, 225, 230, as shown, e.g., in FIG. 2, arranged to broadcast transport blocks transporting services A,B,C to one or more wireless devices 130, 131, 132, 133. At least one of the MBSFN transmitters 230 is associated to both the first 210 and to the second 220 MBSFN, and possibly also to the third MBSFN 530, and the server device 250 is arranged to provide information to wireless devices 130, 131, 132, 133 regarding said broadcasted services.

According to an example in an LTE wireless communication system, the wireless communication system server device 250 controls the services that are broadcasted in each MBSFN. The wireless communication system server device 250 does not control, e.g., allocation of resources in the MBSFN. This is controlled by a multicast Coordination Entity (MCE) and the individual eNBs. Thus, the wireless communication system server device 250 is arranged to at least partly control the first and the second MBSFN.

According to aspects, the server device 250 further comprises a Group Communication Service Application Server (GCS AS) according to 3GPP TS 22.468 V13.0.0 2014-12.

According to aspects, the provided information comprises information regarding which transported services in the first MBSFN 210 and in the second MBSFN 220 that are combinable upon reception by a wireless device 131.

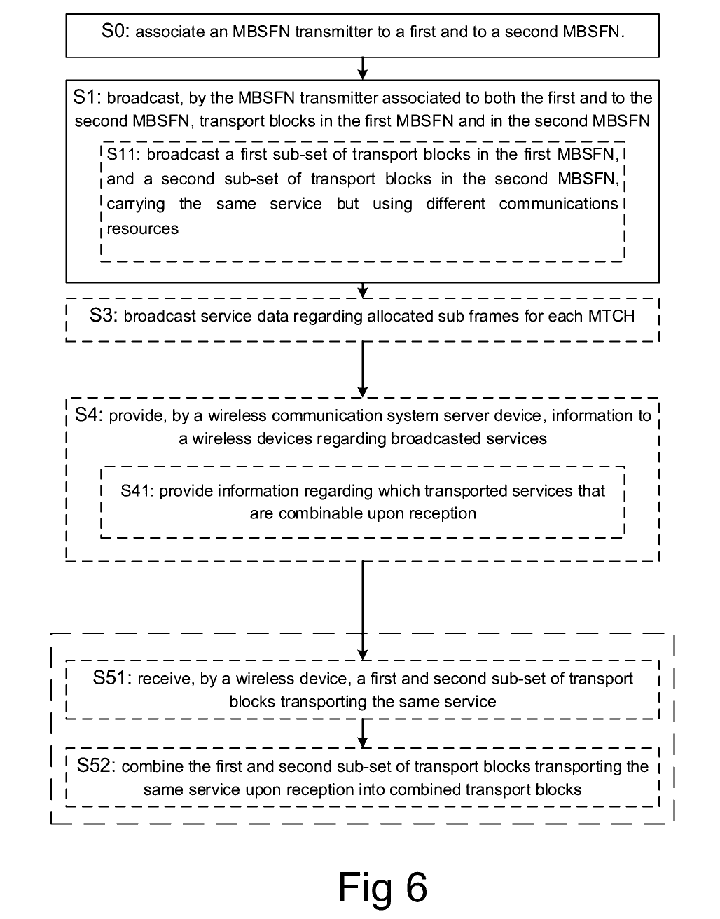

The issues discussed above regarding service continuity for wireless devices moving between different MBSFN areas is also solved by methods disclosed herein. FIG. 6 shows a flowchart illustrating such methods performed in a wireless communication system according to aspects of the present disclosure. In particular, FIG. 6 illustrates a method performed in a wireless communication system 200, 500 with at least a first MBSFN 210 and a second MBSFN 220. The MBSFNs comprise MBSFN transmitters 215, 225, 230, as illustrated in, e.g., FIG. 2 and discussed in connection thereto. The method comprises associating S0 an MBSFN transmitter 230 to both the first 210 and to the second 220 MBSFN, and also S1 broadcasting, by the MBSFN transmitter 230 associated to both the first 210 and to the second 220 MBSFN, transport blocks in the first MBSFN and in the second MBSFN.

The method steps performed in the wireless communication system have already been discussed in connection to FIGS. 2-5 above, and will therefore not be discussed again in detail here. The methods disclosed herein are associated with the same advantages as already mentioned in connection to the devices discussed above.

According to aspects, the broadcasting S1 further comprises S11 broadcasting, by the MBSFN transmitter 230 associated to both the first 210 and to the second 220 MBSFN, a first sub-set of transport blocks in the first MBSFN 210, and a second sub-set of transport blocks in the second MBSFN 220, the first and second subset of transport blocks being arranged to transport the same service B but using different communications resources B-f2, B-f3.

According to aspects, the method further comprises S3 broadcasting service data regarding allocated sub frames for each Multicast-Broadcast Multimedia Service, Traffic Channel (MTCH).

According to aspects, the method further comprises S51 receiving, by a wireless device 131, the first and second sub-set of transport blocks transporting the same service, and also S52 combining, by the wireless device 131, the first and second sub-set of transport blocks transporting the same service into combined transport blocks having an improved transport block quality compared to the transport block quality before combining.

According to aspects, the method further comprises S4 providing, by a wireless communication system server device 250, information to wireless devices regarding broadcasted services.

According to aspects, the method further comprises providing S41 information regarding which transported services in the first MBSFN 210 and in the second MBSFN 220 that are combinable by a wireless device 131 upon reception.

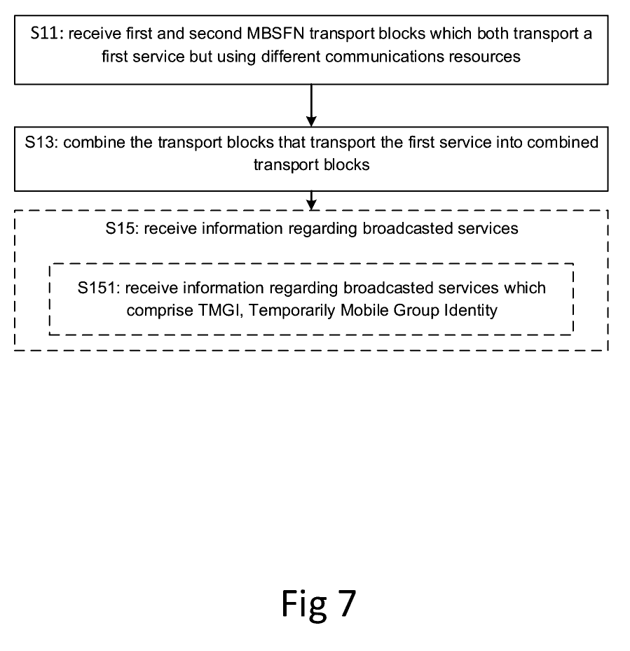

FIG. 7 shows a flowchart illustrating methods performed in a wireless device according to aspects of the present disclosure. In particular, there is illustrated a method performed in a wireless device 131 used for MBSFN communication. The method comprises S11 receiving first and second transport blocks which both transport a first service B, but using different communications resources f2, f3, f5, and S13 combining the received first and second transport blocks into a combined transport block having an improved transport block quality compared to a transport block quality before combining.

The method steps performed in the wireless device have already been discussed in connection to FIGS. 2-5 above, and will therefore not be discussed again in detail here.

According to aspects, the method further comprises S15 receiving information regarding the broadcasted services from a wireless communication system server device 250.

According to aspects, the method further comprises S151 receiving information regarding the broadcasted services which comprise Temporarily Mobile Group Identity (TMGI).

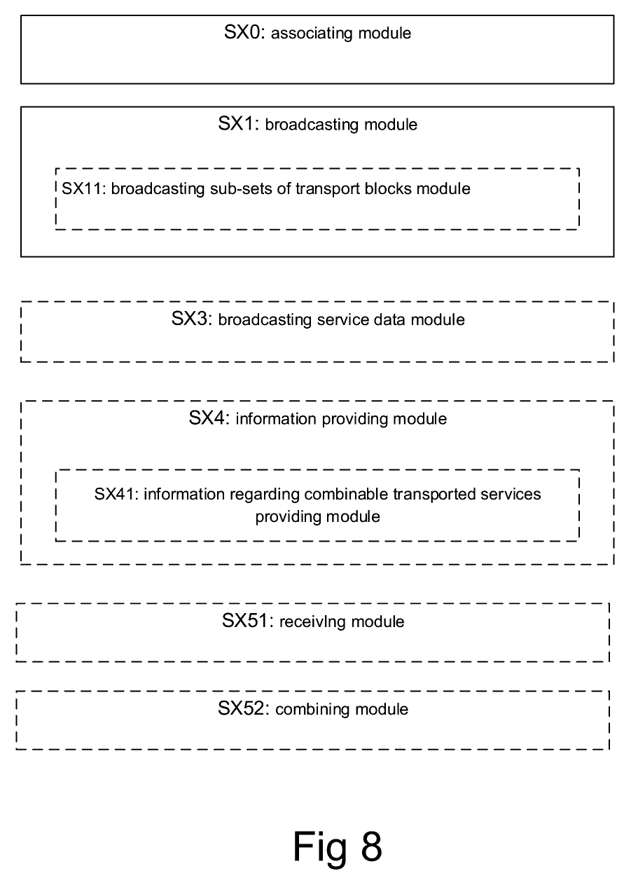

FIG. 8 schematically illustrates a wireless communication system according to aspects of the present disclosure, and as discussed above in connection to FIGS. 1-5. The wireless communication system comprises an associating module SX0 configured to associate an MBSFN transmitter 230 to both the first 210 and to the second 220 MBSFN, and a broadcasting module S1 configured to broadcast, by the MBSFN transmitter 230 associated to both the first 210 and to the second 220 MBSFN, transport blocks in the first MBSFN and in the second MBSFN.

According to aspects, the wireless communication system further comprises a broadcasting sub-sets of transport blocks module SX11 configured to broadcast, by the MBSFN transmitter 230 associated to both the first 210 and to the second 220 MBSFN, a first sub-set of transport blocks in the first MBSFN 210, and a second sub-set of transport blocks in the second MBSFN 220, the first and second subset of transport blocks being arranged to transport the same service B but using different communications resources B-f2, B-f3.

According to aspects, the wireless communication system further comprises a broadcasting service data module SX3 configured to broadcast service data regarding allocated sub frames for each MBMS Traffic Channel (MTCH).

According to aspects, the wireless communication system further comprises a receiving module SX51 and a combining module SX52 configured to receive, by a wireless device 131, the first and second sub-set of transport blocks transporting the same service, and to combine, by the wireless device 131, the first and second sub-set of transport blocks transporting the same service into combined transport blocks having an improved transport block quality compared to the transport block quality before combining, respectively.

According to aspects, the wireless communication system further comprises an information providing module SX9 configured to provide, by a wireless communication system server device 250, information to wireless devices regarding broadcasted services.

According to aspects, the wireless communication system also comprises a further information providing module SX91 configured to provide information regarding which transported services in the first MBSFN 210 and in the second MBSFN 220 that are combinable by a wireless device 131 upon reception.

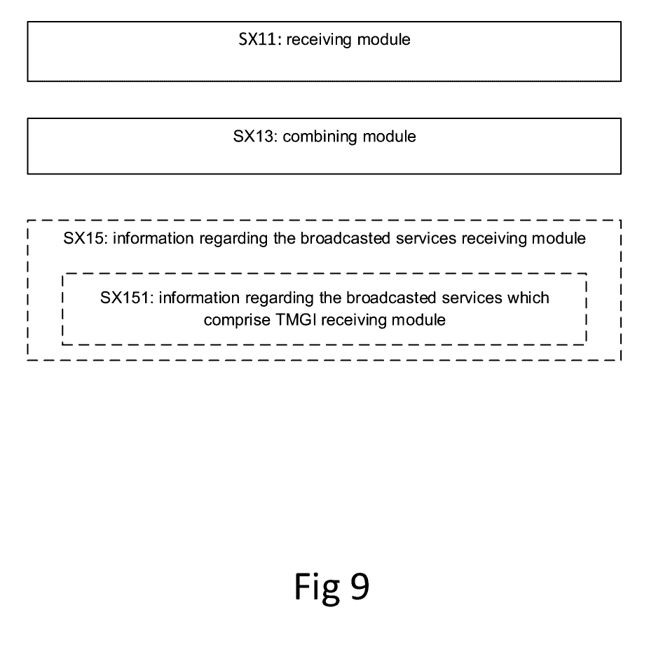

FIG. 9 schematically illustrates a wireless device according to aspects of the present disclosure, and as discussed above in connection to FIGS. 1-5. The wireless device comprises a receiving module SX11 configured to receive first and second transport blocks which both transport a first service B but using different communications resources f2, f3, f5, and a combining module SX13 configured to combine the received first and second transport blocks into a combined transport block having an improved transport block quality compared to a transport block quality before combining.

According to aspects, the wireless device also comprises a second information receiving module SX15 configured to receive information regarding the broadcasted services from a wireless communication system server device 250.

According to aspects, the wireless device also comprises a third information receiving module SX151 configured to receive information regarding the broadcasted services which comprise Temporarily Mobile Group Identity (TMGI).

The various aspects of the methods described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1-32. (canceled)

33. A wireless communication system, comprising:
a first Multicast-Broadcast Single Frequency Network (MBSFN);
a second MBSFN;
each of the first and second MBSFN comprising MBSFN transmitters configured to broadcast transport blocks by using communications resources, the transport blocks transporting services to one or more wireless devices in the wireless communication system;
wherein at least one of the MBSFN transmitters is:
associated with both the first and the second MBSFN; and
configured to broadcast transport blocks transporting one or more services in both the first and in the second MBSFN.

34. The wireless communication system of claim 33, wherein the communications resources comprise any of: frequency bands, time slots, Long Term Evolution (LTE) sub-frames, or a combination of frequency bands and time slots.

35. The wireless communication system of claim 33:
wherein the wireless communication system is a cellular communication system; and
wherein an MBSFN transmitter is a Radio Base Station (RBS), or an eNodeB, of the cellular communication system.

36. The wireless communication system of claim 33, wherein a first sub-set of transport blocks broadcasted in the first MBSFN by the at least one MBSFN transmitter associated with both the first and the second MBSFN, and a second sub-set of transport blocks broadcasted in the second MBSFN by the at least one MBSFN transmitter, are arranged to transport the same service but using different communications resources.

37. The wireless communication system of claim 36, wherein the first and second sub-sets of transport blocks transporting the same service are combinable upon reception by a wireless device into combined transport blocks having an improved transport block quality compared to the transport block quality before combining.

38. The wireless communication system of claim 33, further comprising at least one server device configured to provide information to the one or more wireless devices regarding broadcasted services in the first and in the second MBSFN.

39. The wireless communication system of claim 38, wherein the server device comprises Group Communication Service Application Server (GCS AS) according to 3GPP TS 22.468 V13.0.0 2014-12.

40. The wireless communication system of claim 33, wherein the provided information is a Temporarily Mobile Group Identity (TMGI).

41. The wireless communication according to claim 38, wherein the provided information comprises information regarding which transported services in the first MBSFN and in the second MBSFN that are combinable upon reception by a wireless device.

42. The wireless communication system of claim 33:
wherein the wireless communication system further comprises a third MBSFN;
wherein at least one of the MBSFN transmitters is associated with the first MBSFN, the second MBSFN, and the third MBSFN.

43. The wireless communication system of claim 33, wherein the wireless communication system has a reduced number of reserved cells compared to a wireless communication system where each MBSFN transmitter is associated to one MBSFN only.

44. A wireless device configured for Multicast-Broadcast Single Frequency Network (MBSFN) communication, the wireless device configured to receive first and second transport blocks which both transport a first service but using different communications resources, the wireless device configured to combine at least the received first and second transport blocks into a combined transport block having an improved transport block quality compared to a transport block quality before combining.

45. The wireless device of claim 44, wherein the improved transport block quality is at least any one of:
an improved signal to noise ratio;
an improved signal to interference and noise ratio;
an improved transport block error resilience; and
an improved transport block error probability.

46. The wireless device of claim 44, wherein the wireless device is further configured to receive information regarding broadcasted services in one or more MBSFNs from a wireless communication system server device.

47. The wireless device of claim 44, wherein the wireless device is further configured to receive information comprising Temporarily Mobile Group Identity (TMGI) from a wireless communication system.

48. The wireless device of claim 46, wherein the received information comprises information regarding which transported services in two or more MBSFNs that are combinable upon reception by a wireless device.

49. A wireless communication system server device configured to at least partly control at least a first Multicast-Broadcast Single Frequency Network (MBSFN) and a second MBSFN, each MBSFN comprising MBSFN transmitters arranged to broadcast transport blocks transporting services to one or more wireless devices; wherein at least one of the MBSFN transmitters is associated with both the first and the second MBSFN; and wherein the server device is arranged to provide information to wireless devices regarding the broadcasted services.

50. The server device of claim 49, further comprising a Group Communication Service Application Server (GCS AS) according to 3GPP TS 22.468 V13.0.0 2014-12.

51. The server device of claim 49, wherein the provided information comprises information regarding which transported services in the first MBSFN and in the second MBSFN that are combinable upon reception by a wireless device.

52. A method performed in a wireless communication system with at least a first Multicast-Broadcast Single Frequency Network (MBSFN) and a second MBSFN; the MBSFNs comprising MBSFN transmitters, the method comprising;
associating an MBSFN transmitter with both the first and the second MBSFN; and
broadcasting, by the MBSFN transmitter associated with both the first and the second MBSFN, transport blocks in the first MBSFN and in the second MBSFN.

53. The method of claim 52:
wherein the broadcasting comprises broadcasting, by the MBSFN transmitter associated with both the first and the second MBSFN, a first sub-set of transport blocks in the first MBSFN, and a second sub-set of transport blocks in the second MBSFN;
wherein the first and second subset of transport blocks are arranged to transport the same service but using different communications resources.

54. The method of claim 52, wherein the method further comprises broadcasting service data regarding allocated sub-frames for each Multicast Traffic Channel (MTCH).

55. The method of claim 53:
further comprising receiving, by a wireless device, the first and second sub-set of transport blocks transporting the same service; and
combining, by the wireless device, the first and second sub-set of transport blocks transporting the same service into combined transport blocks having an improved transport block quality compared to the transport block quality before combining.

56. The method of claim 52, further comprising providing, by a wireless communication system server device, information to wireless devices regarding broadcasted services.

57. The method of claim 56, wherein the provided information is information regarding which transported services in the first MBSFN and in the second MBSFN that are combinable by a wireless device upon reception.

58. A computer program product stored in a non-transitory computer readable medium for controlling a wireless communication system, the wireless communication system having at least a first Multicast-Broadcast Single Frequency Network (MBSFN) and a second MBSFN; the MBSFNs comprising MBSFN transmitters; the computer program product comprising software instructions which, when run on one or processors of the wireless communication system, causes the wireless communication system to:
associate an MBSFN transmitter with both the first and the second MBSFN; and
broadcast, by the MBSFN transmitter associated with both the first and the second MBSFN, transport blocks in the first MBSFN and in the second MBSFN.

59. A method performed in a wireless device used for Multicast-Broadcast Single Frequency Network (MBSFN) communication, the method comprising:
receiving first and second transport blocks which both transport a first service but using different communications resources;
combining the received first and second transport blocks into a combined transport block having an improved transport block quality compared to a transport block quality before combining.

60. The method of claim 59, further comprising receiving information regarding the broadcasted services from a wireless communication system server device.

61. The method of claim 59, wherein the information comprises a Temporarily Mobile Group Identity (TMGI).

62. A computer program product stored in a non-transitory computer readable medium for controlling wireless device used for Multicast-Broadcast Single Frequency Network (MBSFN) communication, the computer program product comprising software instructions which, when run on one or more processors of the wireless device, causes the wireless device to:
receive first and second transport blocks which both transport a first service but using different communications resources;
combine the received first and second transport blocks into a combined transport block having an improved transport block quality compared to a transport block quality before combining.

63. A Multicast-Broadcast Single Frequency Network (MBSFN) transmitter associated with both a first MBSFN and a second MBSFN, and configured to broadcast transport blocks transporting one or more services in both the first and in the second MBSFN.

64. The MBSFN transmitter of claim 63, wherein the MBSFN transmitter is a Radio Base Station (RBS), or an eNodeB, in a wireless communication system.
